(19) United States
(12) Patent Application Publication
(10) Pub. No.: US 2008/0141495 A1
(43) Pub. Date: Jun. 19, 2008

(54) Lockable hinge construction

(76) Inventor: Michael P. Fisher, Edina, MN (US)

Correspondence Address: MERCHANT & GOULD PC, P.O. BOX 2903, MINNEAPOLIS, MN, 55402-0903, US

(21) Appl. No.: 11/641,427

(22) Filed: Dec. 18, 2006

(51) Int. Cl. E05D 11/10; E04B 1/38

(52) U.S. Cl. 16/343; 24/489

(57) ABSTRACT

A lockable hinge is disclosed, as well as a panel assembly and panel kit including the hinge. The lockable hinge includes first and second extension members. The lockable hinge also includes a hinge assembly pivotally connecting the first and second extension members about an axis. The hinge assembly includes a first sleeve associated with the first extension member and a second sleeve associated with the second extension member. The hinge assembly further includes a hinge pin mechanism, at least partially within the first sleeve and the second sleeve. The first and second extension members are lockable at a plurality of angular positions by axial movement of at least one of the first sleeve, the second sleeve, or the hinge pin mechanism. Panels can be connected at the lockable hinge. Various structures are thereby constructed.

### TECHNICAL FIELD

The present invention relates to a hinge construction. More specifically, the present invention relates to a lockable hinge device useable with a panel.

### BACKGROUND

Portable play area units, such as play pens or play houses, provide a safe area within which a young child can play. Play area units may be constructed from panels of various sizes that are fixedly attached to each other in various configurations. The variety of components allows the play area units to be constructed in different sizes or configurations to fit the unit into the surrounding space, such as a play room or living room of a house.

Hinge units are known that can be incorporated into such portable play area units. One example play area unit having a hinged construction is disclosed in U.S. Pat. No. 4,712,773, assigned to North States Industries, Inc. of Minneapolis, Minn.

The various hinge and panel constructions incorporated into play area units can be difficult to construct by adults, or children, due to the variety and small size of the interlocking parts involved in the construction of the unit. The interlocking mechanisms for such play areas may therefore require those constructing the unit to have highly developed motor skills. For this reason, although a child intending to use the portable play unit may want to help design and build the play area unit, he or she may have difficulty due to the complicated interlocking mechanisms involved and the lack of development of the child's coordination and motor skills.

For these and other reasons, improvements are desired.

### SUMMARY

The above and other problems are solved by the following:

In general, a lockable hinge device is disclosed. The hinge device is useable with one or more panels to form a variety of types of structures. The hinge can be locked in a variety of configurations.

According to a first aspect, a lockable hinge is disclosed. The lockable hinge includes first and second extension members. The lockable hinge also includes a hinge assembly pivotally connecting the first and second extension members about an axis. The hinge assembly includes a first sleeve associated with the first extension member and a second sleeve associated with the second extension member. The hinge assembly further includes a hinge pin mechanism, at least partially within the first sleeve and the second sleeve. The first and second extension members are lockable at a plurality of angular positions by axial movement of at least one of the first sleeve, the second sleeve, or the hinge pin mechanism.

In a second aspect, a panel assembly is disclosed. The panel assembly includes first and second panels and a hinge assembly pivotally connecting the first and second panels about an axis. The hinge assembly includes a first extension member attached to the first panel and a second extension member attached to the second panel. The hinge assembly also includes a first sleeve associated with the first extension member and a second sleeve associated with the second extension member, wherein the second sleeve is axially aligned with the first sleeve. A hinge pin mechanism is at least partially within the first sleeve and the second sleeve. The hinge assembly is lockable at a plurality of angular positions by axial movement of at least one of the first sleeve, the second sleeve, or the hinge pin mechanism.

In a third aspect, a panel kit is disclosed. The panel kit includes a plurality of panels and a plurality of lockable hinges. The lockable hinges include first and second extension members and a hinge assembly pivotally connecting the first and second extension members about an axis. The hinge assembly includes a first sleeve associated with the first extension member and a second sleeve associated with the second extension member. The second sleeve is axially aligned with the first sleeve. A hinge pin mechanism is at least partially within the first sleeve and the second sleeve. The first and second extension members are lockable at a plurality of angular positions by axial movement of at least one of the first sleeve, the second sleeve, or the hinge pin mechanism. And, the plurality of lockable hinges are attachable to one or more of the plurality of panels.

In a fourth aspect, a method of building a structure using at least first and second panels and a lockable hinge is disclosed. The first and second panels have first and second grooves, respectively. The lockable hinge has first and second extension members including first and second tongues respectively. The lockable hinge is lockable in one of a plurality of configurations. The method includes inserting the first panel into the first extension member until the first tongue snaps into the first groove; inserting the second panel into the second extension member until the second tongure snaps into the second groove; and locking the hinge into one of the plurality of configurations.

### BRIEF DESCRIPTION OF THE DRAWINGS

FIG. 1 is an exploded front perspective view of a lockable hinge according to a possible embodiment of the present disclosure;

FIG. 2 is a front perspective view of the lockable hinge of FIG. 1;

FIG. 3 is a front plan view of the lockable hinge of FIG. 1;

FIG. 4 is a rear plan view of the lockable hinge of FIG. 1;

FIG. 5 is a top or bottom plan view of the lockable hinge of FIG. 1;

FIG. 6 is a side plan view of the lockable hinge of FIG. 1;

FIG. 7 is a front plan view of the lockable hinge of FIG. 1 in a possible locked configuration with cylindrical sleeves removed to illustrate the hinge pin mechanism;

FIG. 8 is a front plan view of the lockable hinge of FIG. 1 in a possible unlocked configuration with cylindrical sleeves removed to illustrate the hinge pin mechanism;

FIG. 9 is a top cross-sectional view of the lockable hinge of FIG. 1;

FIG. 10 is a close-up top cross-sectional view of a portion of the lockable hinge device of FIG. 1;

FIG. 11 is a front perspective view of a panel assembly including a lockable hinge attached to a panel useable in accordance with the above embodiments;

FIG. 12 is a front perspective view of a child play structure formed from lockable hinges and panels according to a possible embodiment of the present disclosure;

FIG. 13 is a front perspective view of a lockable hinge according to a further possible embodiment of the present disclosure, in a locked position; and

FIG. 14 is a front perspective view of the lockable hinge of FIG. 7 in an unlocked position.

### DETAILED DESCRIPTION

Reference will now be made in detail to examples of inventive aspects of the present disclosure, which are illustrated in the accompanying drawings. Wherever possible, the same reference numbers will be used throughout the drawings to refer to the same or like parts.

In general, the present disclosure relates to a lockable hinge and a panel construction formed from panels connected via lockable hinges. Preferably, the lockable hinge can be locked in a variety of configurations. The lockable hinge includes extension members pivotally connected by a hinge assembly. In general, the hinge assembly includes a first sleeve, a second sleeve, and a hinge pin mechanism at least partially within the sleeves. The first and second extension members are lockable at a plurality of angular positions by axial movement of the first sleeve, the second sleeve, or the hinge pin mechanism.

The various embodiments of the lockable hinge and associated panel construction are useable in a variety of applications. In one application, the hinge and panel construction provides a large muscle play toy for children. In such an application, a child or adult might construct structures using hinges and panels according to the present disclosure. In a further application, the hinge provides an adjustable, lockable door stop for interior and exterior doors and other hinged structures. Additional applications are also possible using the lockable hinge or hinge and panel constructions disclosed, such as the construction of booths, cubicles, or other structures.

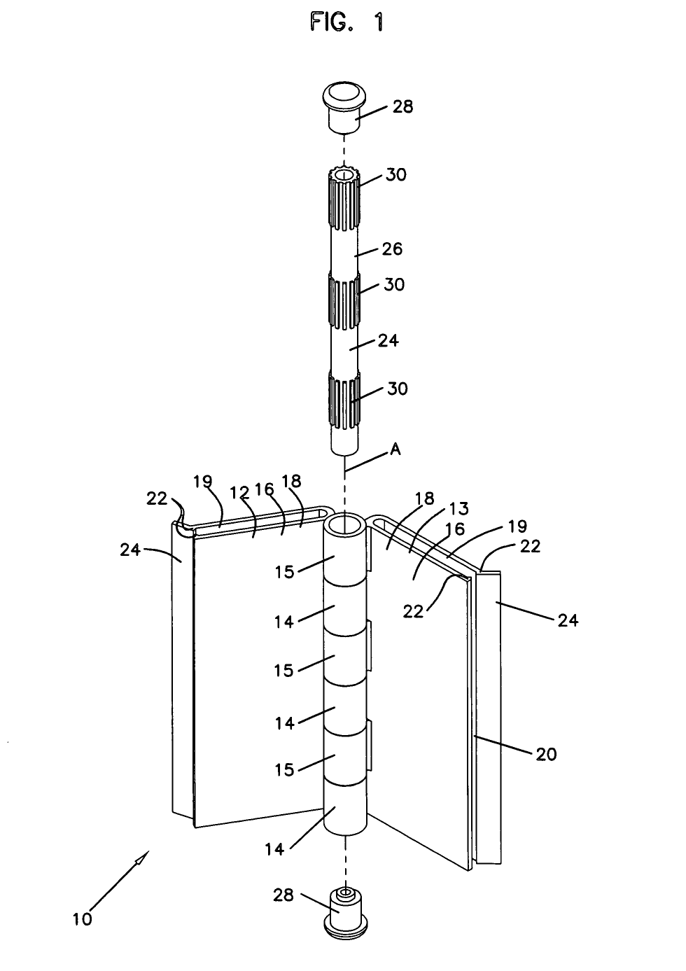

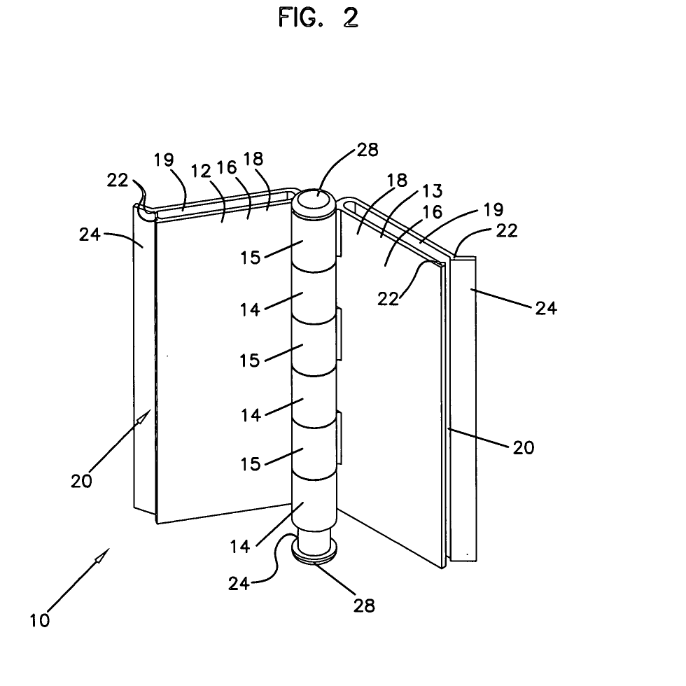

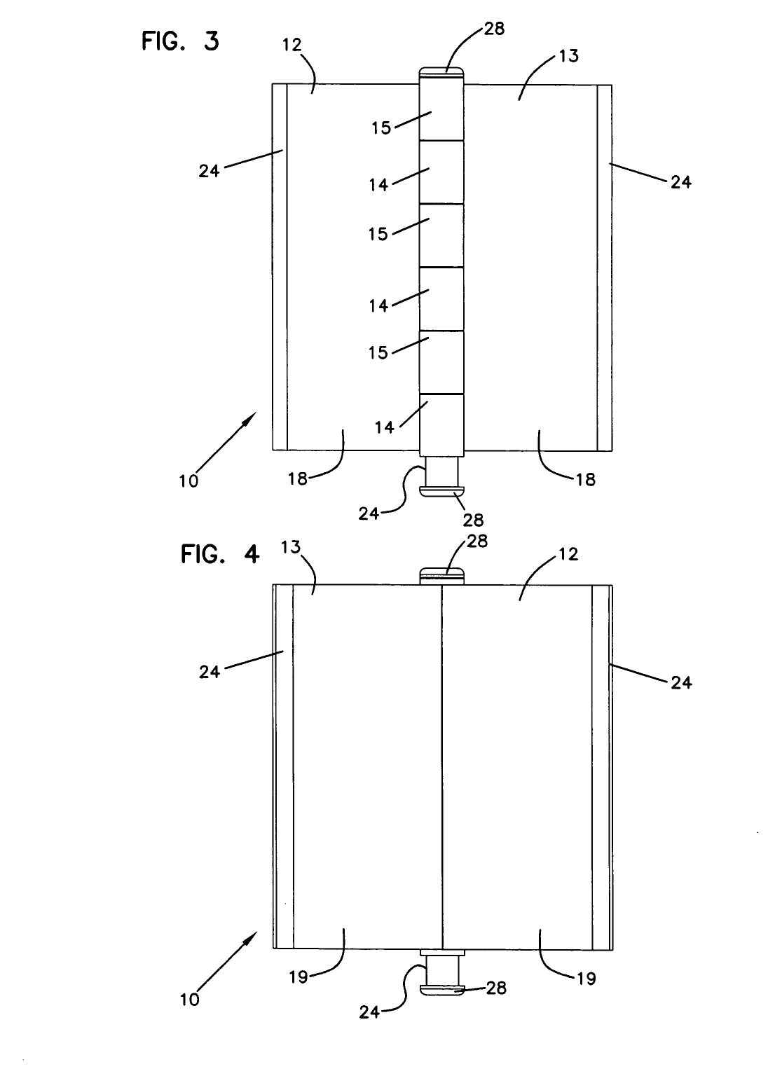

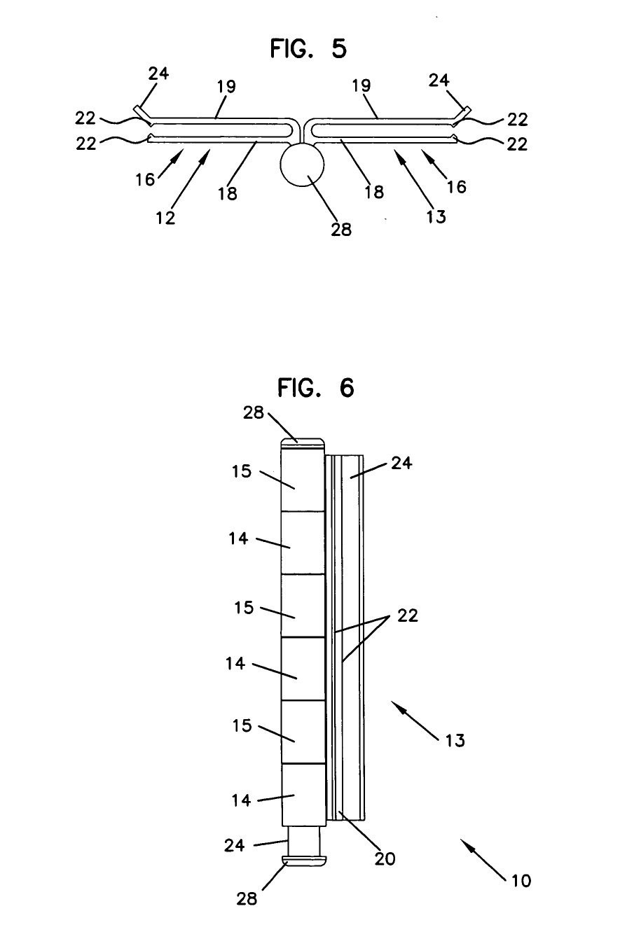

Referring now to FIGS. 1-10, a lockable hinge 10 is shown in detail. The lockable hinge 10 pivots about an axis A, but selectably locks at a number of angular positions. In the embodiment shown, the hinge locks or unlocks by axial movement of the hinge pin. However, additional locking configurations are possible.

The lockable hinge 10 includes extension members 12, 13 that are preferably integrally formed with sleeves 14, 15. In the embodiment shown, extension member 12 is integrally formed with three sleeves 14, while extension member 13 is integrally formed with three sleeves 15. In further embodiments, the extension members 12, 13 can be bolted, welded, or otherwise non-rotatably affixed to the corresponding sleeves 14, 15. In still other embodiments, one or more of both sleeves 14, 15 can be used.

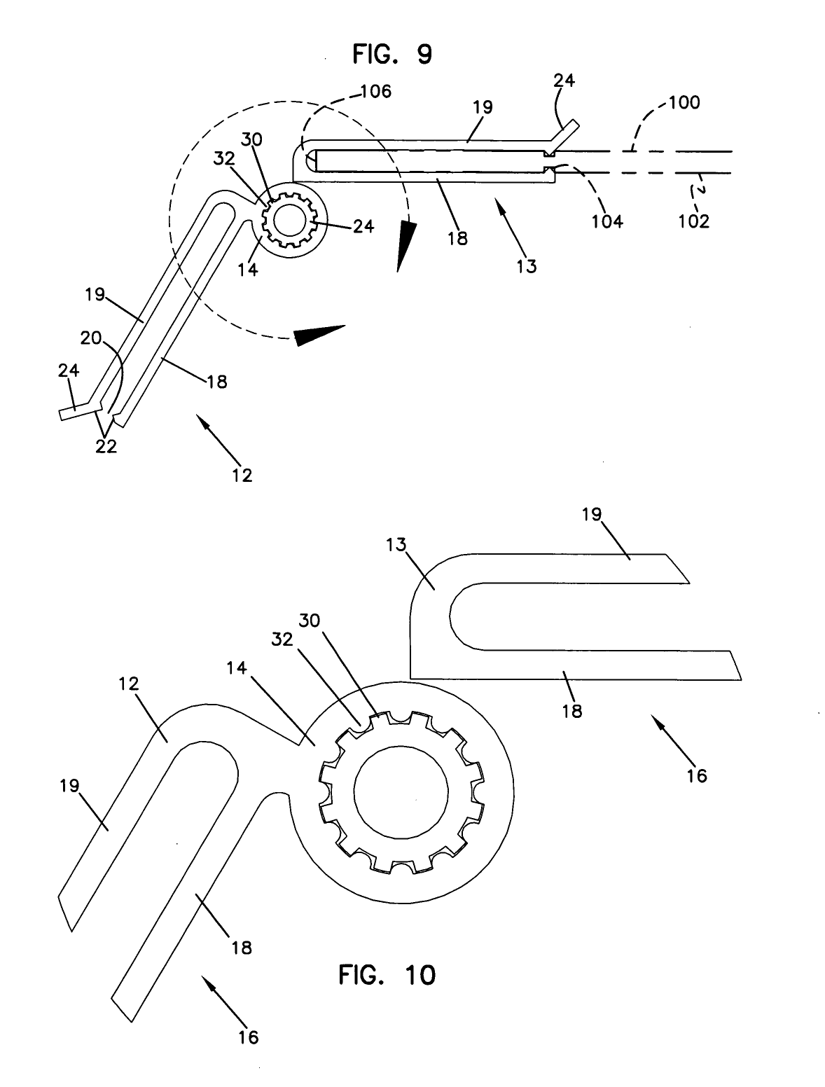

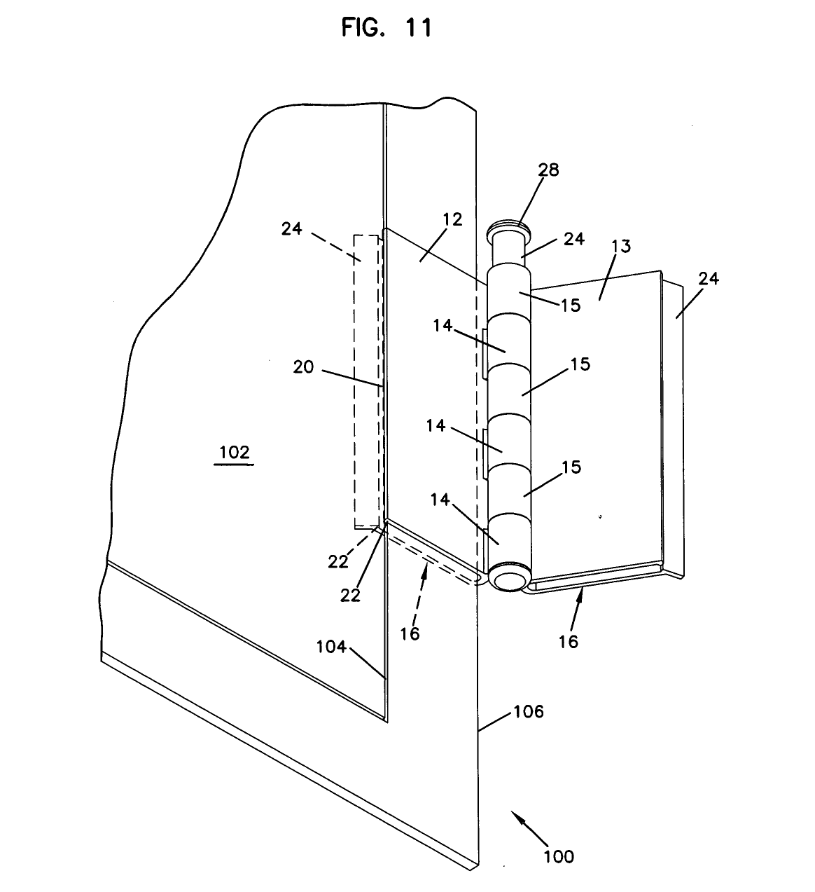

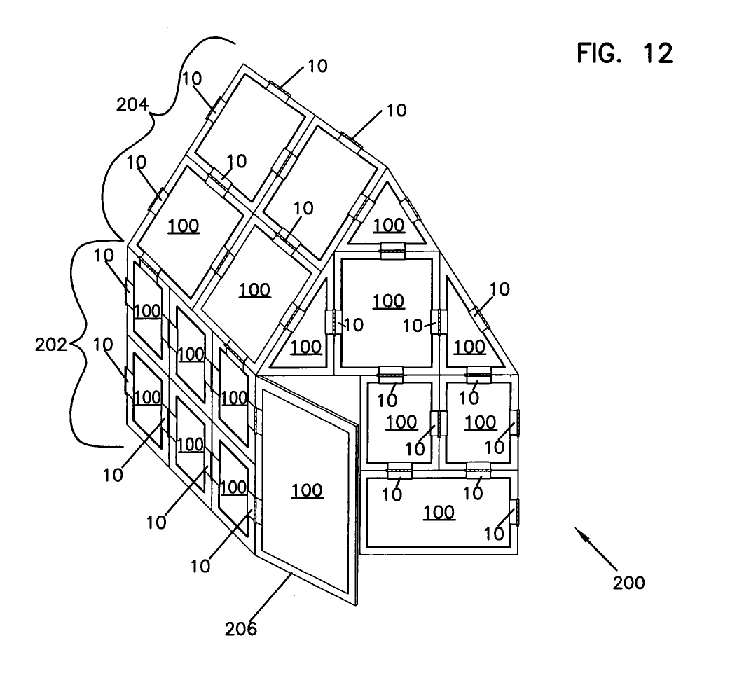

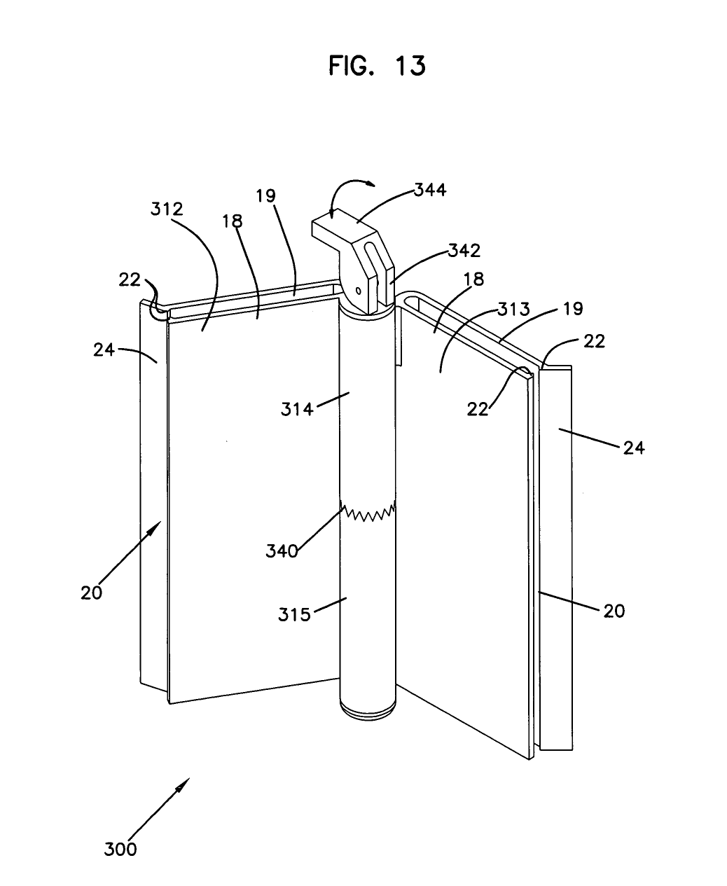

Each extension member 12, 13 forms a sheath 16, constructed from opposed rigid, or semi-rigid, sheets 18, 19. The sheath 16 includes a slotted opening 20 configured to accept insertion of a panel, such as is shown below in FIGS. 11-12. The sheets 18, 19 each include an opposed tongue 22 extending from the sheath 16, proximate to and running along the opening 20. The tongue 22 provides additional grip for the sheath 16 in gripping a panel when a panel such as the one shown in FIG. 11 is inserted into the opening 20. A flange 24 extends along sheet 19 at the opening, and angularly extends away from sheet 18. The flange 24 provides a grip location, allowing a user to easily pry apart the sheets 18, 19 to remove a panel once inserted into the opening 20 and held by the tongues 22. The flange also improves insertion of the panel by guiding the panel into the sheath 16. One example of interconnection of a panel with a lockable hinge 10 is described in greater detail below, and illustrated in FIGS. 9 and 11.

The sleeves 14, 15 are axially aligned about the axis A. In the embodiment shown, the sleeves 14, 15 are alternately adjacent along the length of the extension members 12, 13. However, in further embodiments, the sleeves 14, 15 extend less than the entire length of the extension members.

The sleeves 14, 15 are hollow and accept a hinge pin mechanism, such as a hinge pin 24. The hinge pin 24 includes a cylindrical body 26 and end caps 28 at opposing ends. Preferably, the hinge pin 24 also includes axial protrusions 30 around the cylindrical body 26. The hinge pin 24 extends beyond the axially aligned sleeves 14, 15, and is movable along axis A between two positions, a locked position and an unlocked, pivotable position.

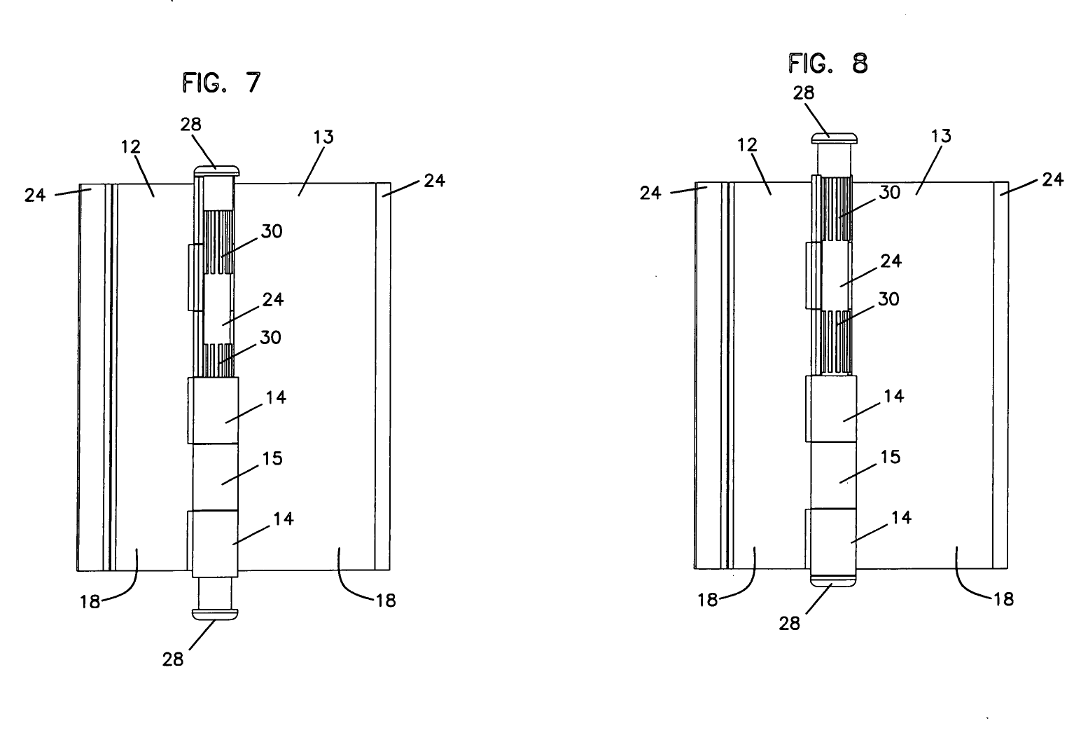

Referring now to FIGS. 7-10, the unlocked and locked positions of the hinge pin 24 are shown in detail. In FIGS. 7-8, a number of the sleeves 14, 15 are removed to show the position of the hinge pin 24 and the axial protrusions 30 when the hinge 10 is locked and unlocked. In FIG. 7, the axial protrusions 30 of the hinge pin 10 interlock with both of adjacent sleeves 14, 15, preventing pivotal rotation of the hinge 10. In FIG. 8, the axial protrusions 30 of the hinge pin 24 reside completely within the sleeve 14, but not the sleeve 15. Therefore, the hinge pin interlocks only with the sleeve 14 associated with extension member 12, and the sleeve 15 and extension member 13 are allowed to freely pivot with respect to extension member 12.

FIGS. 9-10 show a cutaway top view of the interlocking between the hinge pin 24 and a sleeve, such as sleeve 14, 15. Preferably, each sleeve 14, 15 includes axial inner slots 32 that interlock with the axial protrusions 30 of the hinge pin 24. In the locked position the axial inner slots 32 of sleeve 14 are aligned with the axial inner slots 32 of sleeve 15. The hinge pin 24 can therefore be moved along axis A and slide into sleeve 15, forming the locked position shown, but with the extension members 12, 13 residing at any angular position for which the axial inner slots of the sleeves 14, 15 are aligned.

The hinge 10 can be manufactured from a variety of rigid or semi-rigid materials, such as plastic or metal. In one embodiment, the hinge 10 is a product of blow molding. In a further embodiment, the hinge is injection molded. Additional manufacturing techniques and materials are possible as well.

Referring now to FIG. 11, an example panel assembly is shown, including the lockable hinge 10 and a panel 100. Multiple hinges 10 and panels 100 can be used to form a variety of structure, based on the desires of a user.

Preferably, the panel 100 includes a body 102 having a groove 104 formed a distance from one or more edges 106. The panel body 102 can be a variety of shapes, sizes, and colors. Although the panel body 102 shown is a rectangular shape, additional shapes, such as triangular shapes, semi-circular shapes, or other shapes are possible as well. The panel body 102 can be planar or nonplanar. The panel body 102 generally includes an appropriate portion for attachment of one or more hinges as described herein.

Preferably, the distance from the groove 104 to the edge 106 of the panel 104 is equal to or slightly less than the depth of the sheath 16 of the lockable hinge, such that when the panel is inserted into the lockable hinge, the tongue(s) 22 in the sheath 16 reside in the groove 104 in the panel 100. The groove 104 mates with a tongue portion of a sheath 16 to form a tongue-in-groove configuration, as shown in FIG. 9, above. For example, to match the tongue 22 of the hinge 10, the groove 104 is straight at least in a portion of intended connection. Alternate configurations are possible as well, which may include hinges having a curved or angled tongue and corresponding groove.

In one embodiment, the groove 104 extends along a perimeter of the body; however, in other embodiments the groove extends along fewer than all sides of the panel. Additionally, the groove 104 can be located on one or both sides of the panel.

Referring now to FIG. 12, an exemplary child play structure 200 is shown according to a possible embodiment of the present disclosure. The structure 200 shown is formed from a plurality of lockable hinges 10 and panels 100 of various sizes. The structure 200 includes various walls 202, a roof 204, and a door 206. In the structure 200 shown, the hinges 10 form structural and functional features of the play structure 200. Specifically, the hinges 10 are used in a straight, locked position to join adjacent panels 100 to create the wall 202 from multiple panels 100. Hinges 10 are used in an angled, locked position to connect the roof 204 to the walls 202. Additionally, by leaving one or more of the hinges 10 in an unlocked position, a panel 100 can be used as a door 206 for the play structure 200.

Referring to FIGS. 1-12, the structure 200 can be built by using a plurality of lockable hinges 10 and panels 100 of various sizes, or shapes. The user can connect two panels 100 together using a lockable hinge 10. The user would insert a first panel 100 into one of the sheaths 16 using the flange 24 to guide the panel 100 into the slotted opening 20 until the groove 104 locks into the sheath 16 by engagement with the tongue 22. Likewise, the user can insert a second panel 100 into the opposite slotted opening 20 until the groove 104 locks in the sheath 16 by engagement with the tongue 22.

The lockable hinge can be locked into a variety of configurations. For example, the user can decide to form a straight section, such as the wall 202 of structure 200, by locking the hinge such that a 180 degree straight section is formed. The user can decide to form a 90 degree section by locking the hinge accordingly to form a 90 degree corner of the structure 200. The user can decide to form a 45 degree section by locking the hinge accordingly to form the connection between the wall 202 and the roof 204.

Using the above described method, the user can build a variety of structures by simply having a plurality of hinges 10 and panels 100. Numerous other possibilities exist as well, such as themes, special kits, and other applications. For example kits having special panel shapes and sizes related to forming special characters, figures, or objects, such as a toy store, bank with a safe, castle, crazy maze, school, spaceship, boat, house with peaked roof, house with slanted roof, house or fort with flat roof, log cabin, firetruck, puppet theatre, childrens theatre, zoo, pet shop, lost mines. spacestation, fun house with mirrors, etc. Panels can be manufactured such that they can be colored or drawn on.

Other structures can be built using the panels and hinges described herein, such as temporary trade show booths or cubicles in offices.

Additional or alternative structures can be constructed to fit larger or smaller spaces, using appropriate numbers/sizes of panels 100 and hinges 10. Further, additional types of panels and hinges (such as the hinge 300, below) can be used in the structure in combination with or in place of the hinges and panels shown.

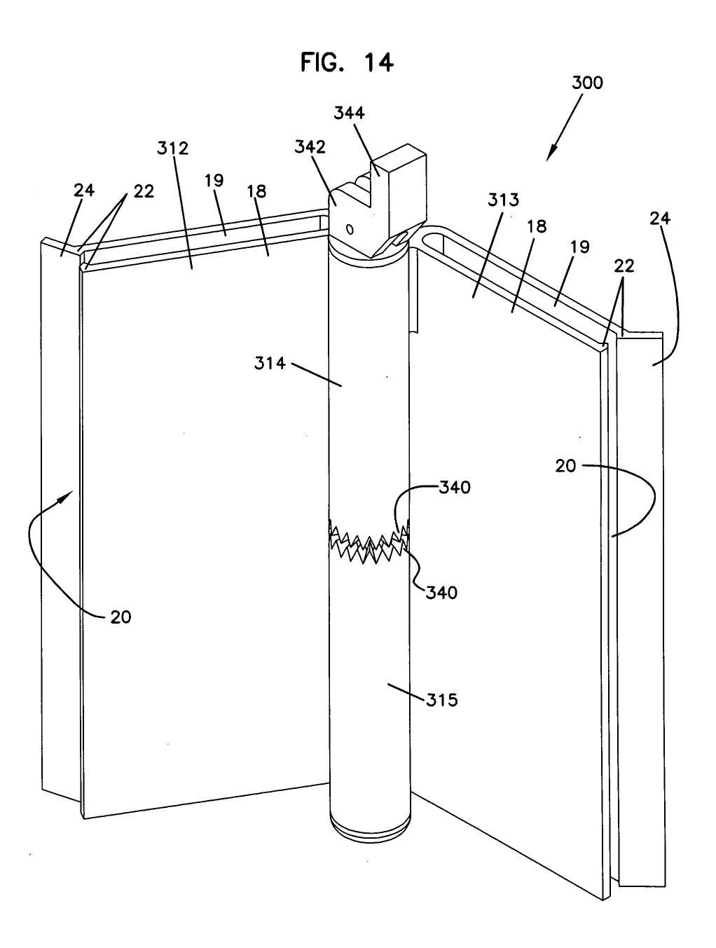

Referring now to FIGS. 13-14, a lockable hinge 300 is shown according to another possible embodiment of the present disclosure. FIG. 13 shows a locked position, and FIG. 14 shows an unlocked position. The lockable hinge 300 also pivots about an axis A, and selectably locks at a number of angular positions. The lockable hinge includes extension members 312, 313 integrally formed with two sleeves 314, 315. The extension members correspond to the extension members 12, 13 described above.

The sleeves 314, 315 each include interlockable teeth 340 on adjacent edges. The sleeves are held apart by a biasing force, such as a spring (not shown), separating the interlocking teeth 340. When the adjacent edges are separated by the biasing force, the teeth 340 do not interlock and the hinge 300 allows pivotal movement. When the biasing force is overcome and adjacent edges are moved into axial contact, the teeth 340 interlock to prevent pivotal movement of the extension members 314, 315.

A hinge pin mechanism 324 includes a clamp 342 attached to the sleeves 314, 315. The clamp 342 controls axial movement of the sleeves 314, 315. The claim 342 includes a tab 344, which is movable between locked and unlocked positions. In the unlocked position, the clamp 342 does not counteract the biasing force to move the sleeves 314, 315 together. Moving the tab to the locked position counteracts the biasing force and causes the sleeves 314, 315 to move axially toward each other, interlocking the teeth 340.

In various embodiments such as the one shown, the hinge locks or unlocks by axial movement of sleeves 314, 315. In the embodiment shown, the hinge 300 locks by moving the sleeves 314, 315 together, connecting the interlockable teeth 340 such that pivoting of the hinge is prevented. In a further embodiment, the interlockable teeth 340 are removed, and the hinge 300 locks by friction between the first and second sleeves 314, 315. In still another embodiment, only one of sleeves 314, 315 include teeth, which are compressed into a compressible portion of the opposing sleeve, providing resistance to pivotal rotation.

The lockable hinge 300 can be used in conjunction with the panel 100 or in the structure 200 previously described, in combination with or in place of lockable hinge 10. Additional configurations of lockable hinges and panels can be used as well. Furthermore, although two primary embodiments of lockable hinges are described in the present disclosure, it is understood that the invention is not so limited.

The above specification, examples and data provide a complete description of the manufacture and use of the composition of the invention. Since many embodiments of the invention can be made without departing from the spirit and scope of the invention, the invention resides in the claims hereinafter appended.

1. A lockable hinge, comprising:
first and second extension members;
a hinge assembly pivotally connecting the first and second extension members about an axis, the hinge assembly including:
a first sleeve associated with the first extension member;
a second sleeve associated with the second extension member, the second sleeve axially aligned with the first sleeve;
a hinge pin mechanism at least partially within the first sleeve and the second sleeve;
wherein the first and second extension members are lockable at a plurality of angular positions by axial movement of at least one of the first sleeve, the second sleeve, or the hinge pin mechanism.

2. The lockable hinge of claim 1, wherein the hinge pin mechanism is located at least in part within the first and second sleeves.

3. The lockable hinge of claim 1, wherein the first sleeve is integrally formed with the first extension member and the second sleeve is integrally formed with the second extension member.

4. The lockable hinge of claim 1, wherein each extension member includes one or more panel attachment arrangements.

5. The lockable hinge of claim 1, wherein the hinge pin mechanism includes a hinge pin having axial protrusions extending along a portion of the hinge pin.

6. The lockable hinge of claim 2, wherein the first and second sleeve both include axial inner slots configured to interlock with the axial protrusions on the hinge pin.

7. The lockable hinge of claim 3, wherein, in an unlocked position, the axial protrusions interlock with the slots of the first sleeve in the absence of the axial protrusions interlocking with the slots of the second sleeve.

8. The lockable hinge of claim 3, wherein, in a locked position, the axial protrusions interlock with the axial inner slots of the first sleeve and the axial inner slots of the second sleeve.

9. The lockable hinge of claim 1, wherein the second sleeve is adjacent to the first sleeve.

10. The lockable hinge of claim 9, wherein the first sleeve and the second sleeve include interlockable teeth at adjacent edges.

11. The lockable hinge of claim 10, wherein, in an unlocked position, the interlockable teeth are separated by a biasing mechanism.

12. The lockable hinge of claim 11, wherein the hinge pin mechanism includes a clamp having locked and unlocked positions, wherein the clamp is configured to axially move one or both of the first and second sleeves to interlock the interlockable teeth.

13. The lockable hinge of claim 1, wherein the first and second extension each form a sheath, each sheath having a tongue protruding within the sleeve and positioned to be received by a groove in a panel when the panel is held within the sheath.

14. A panel assembly comprising:
first and second panels; and
a hinge assembly pivotally connecting the first and second panels about an axis, the hinge assembly including:
a first extension member attached to the first panel;
a second extension member attached to the second panel;
a first sleeve associated with the first extension member;
a second sleeve associated with the second extension member, the second sleeve axially aligned with the first sleeve;
a hinge pin mechanism at least partially within the first sleeve and the second sleeve;
wherein the hinge assembly is lockable at a plurality of angular positions by axial movement of at least one of the first sleeve, the second sleeve, or the hinge pin mechanism.

15. The panel assembly of claim 14, wherein the first extension member is integrally formed with the first sleeve and the second extension member is integrally formed with the second sleeve.

16. The panel assembly of claim 15, wherein the extension members each include a sheath configured to accept a panel.

17. The panel assembly of claim 16, wherein the first and second panels each include a groove positioned to accept an inwardly oriented tongue protrusion on the sheath.

18. A panel kit comprising:
a plurality of panels; and
a plurality of lockable hinges, each lockable hinge including:
first and second extension members;
a hinge assembly pivotally connecting the first and second extension members about an axis, the hinge assembly including:
a first sleeve associated with the first extension member;
a second sleeve associated with the second extension member, the second sleeve axially aligned with the first sleeve; and
a hinge pin mechanism at least partially within the first sleeve and the second sleeve;
wherein the first and second extension members are lockable at a plurality of angular positions by axial movement of at least one of the first sleeve, the second sleeve, or the hinge pin mechanism;
wherein the plurality of lockable hinges are attachable to one or more of the plurality of panels.

19. The panel kit of claim 18, wherein each extension member includes one or more panel attachment arrangements.

20. The panel kit of claim 18, wherein the plurality of panels include panels of differing sizes and shapes.

21. The panel kit of claim 18, wherein the panel kit forms a child play structure.

22. A method of building a structure using at least first and second panels having first and second grooves, respectively, and a lockable hinge having first and second extension members including first and second tongues respectively and being lockable in one of a plurality of configurations, the method comprising:
inserting the first panel into the first extension member until the first tongue snaps into the first groove;
inserting the second panel into the second extension member until the second tongure snaps into the second groove; and
locking the hinge into one of the plurality of configurations.

23. A method according to claim 22, further comprising: before locking the hinge, moving a hinge pin axially to allow the first and second extensions to move respective to one another.

24. A method according to claim 22, wherein locking the hinge includes moving a hinge pin axially to lock the first and second extensions respective to one another.
